(19) United States
(12) Patent Application Publication
(10) Pub. No.: US 2008/0236860 A1
(43) Pub. Date: Oct. 2, 2008

(54) ELECTRICAL SWITCH COVER

(75) Inventor: Jeffrey Kent Howe, Gastonia, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: PREVENTION PRODUCTS, INC., Gastonia, NC (US)

(21) Appl. No.: 11/695,356

(22) Filed: Apr. 2, 2007

(51) Int. Cl. H01R 13/447

(52) U.S. Cl. 174/67

(57) ABSTRACT

A cover for temporarily covering a switch positioned within an electrical housing includes a panel section that can be removably attached to the electrical housing, and a casing shaped and sized to cover and contact the switch. The casing is mounted on the panel for a predetermined range of sliding movement relative to the panel, such that sliding of the casing imparts movement of the switch. As such, the electrical switch can be turned “on” and “off” without removing the cover.

### TECHNICAL FIELD AND BACKGROUND OF THE INVENTION

The invention relates to a device for covering a moveable object. A preferred embodiment of the invention comprises a cover for an electrical switch.

When painting or performing other work on interior walls, it is generally desirable to cover the electrical switches, outlets and similar objects positioned in the walls to avoid getting paint or other undesirable material on the switches and outlets, and to provide a safety barrier for workers. As such, there have been a number of devices developed for temporarily covering electrical switches and outlets. For example, U.S. Pat. No. 5,723,816 to Neece and U.S. Pat. No. 5,285,014 to Gilchrist disclose paint shields for electrical switches. However, neither provides a shield that allows for movement of the electrical switch. As such, the shields must be removed every time the user wants to turn the electricity on or off. This is time consuming and inconvenient for the user.

In an effort to overcome and eliminate the aforementioned problems, the present invention was conceived.

### SUMMARY OF THE INVENTION

Therefore, it is an object of the invention to provide a cover that can be removably mounted on an interior wall to cover an appliance such as an electrical switch.

It is another object of the invention to provide a cover for a moveable object such as an electrical switch, in which the switch can be moved without removing the cover.

These and other objectives of the present invention are achieved in the preferred embodiments disclosed in detail below by providing a device for covering a moveable object positioned proximate a structure having a first panel, means for attaching the panel to the structure proximate the moveable object, and a casing adapted to cover and contact the moveable object. The casing is mounted on the panel for a predetermined range of sliding movement on the panel, whereby sliding of the casing imparts movement of the object.

According to another preferred embodiment of the invention, the object is adapted for linear movement, and sliding of the casing imparts linear movement of the object.

According to another preferred embodiment of the invention, the attachment means includes an opening formed in the panel, and a fastener for inserting through the panel opening and removably engaging a complementary void formed in the structure proximate the moveable object so that the panel is removably attached to the structure.

According to another preferred embodiment of the invention, the fastener is a male threaded screw, and the complementary void is a female threaded aperture.

According to another preferred embodiment of the invention, the casing includes a substantially flat base adapted for sliding movement on the panel, and a covering member extending outwardly from the base for receiving and covering the moveable object.

According to another preferred embodiment of the invention, the base of the casing has at least one stopping member formed on a perimeter of the base, and the panel includes at least one receiving member that engages the stopping member at two or more spaced apart points. Engagement of the stopping member and the receiving member prevent further movement of the base on the panel so that a permitted range of movement of the casing on the panel is limited to a predetermined area.

According to another preferred embodiment of the invention, the casing base is substantially rectangular and has first and second stop members formed on opposing sides of the base. The panel includes first and second pairs of spaced apart linearly aligned receiving members that receive and engage the stop members. The base is moveable between a first stopped position in which the stop members engage the first pair of receiving members, and a second stopped position in which the stop members engage the second pair of receiving members, such that movement of the casing on the panel is limited to an area lying between the first and second pairs of receiving members.

According to another preferred embodiment of the invention, the covering member is substantially pyramidal.

According to another preferred embodiment of the invention, the first panel is substantially rectangular, and the device includes second and third panels attached to opposite sides of the first panel.

According to another preferred embodiment of the invention, a fourth panel is attached to the first panel intermediate the second and third panels.

According to another preferred embodiment of the invention, a cover for temporarily covering a switch positioned within an electrical housing includes a panel section, attachment means for removably attaching the panel section to the housing, and a casing shaped and sized to cover and contact the switch. The casing is mounted on the panel for a predetermined range of sliding movement relative to the panel, such that sliding of the casing imparts movement of the switch.

According to another preferred embodiment of the invention, the switch is adapted for linear movement, and sliding of the casing imparts linear movement of the switch.

According to another preferred embodiment of the invention, the attachment means includes an opening formed in the panel, and a fastener is inserted through the panel opening and engages a complementary void formed in the housing, such that the panel is removably attached to the housing.

According to another preferred embodiment of the invention, the casing includes a substantially flat base adapted for sliding movement on the panel, and a substantially pyramidal covering member extending outwardly from the base for receiving and covering the switch.

According to another preferred embodiment of the invention, the panel section includes a first substantially rectangular panel having first and second opposed longitudinal sides and first and second opposed lateral sides.

According to another preferred embodiment of the invention, the panel section includes a second substantially rectangular panel attached to the first lateral side of the first panel, and a third substantially rectangular panel attached to the second lateral side of the first panel.

According to another preferred embodiment of the invention, the panel section also includes a fourth substantially rectangular panel attached to the first longitudinal side of the first panel.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is an environmental perspective view of an electrical switch cover according to a preferred embodiment of the invention;

FIG. 2 is another perspective view of the electrical switch cover of FIG. 1;

FIG. 3 is a cross-sectional side elevation of the electrical switch cover of FIG. 1; and

FIG. 4 is another cross sectional side elevation of the electrical switch cover of FIG. 1.

### DETAILED DESCRIPTION OF THE PREFERRED EMBODIMENT AND BEST MODE

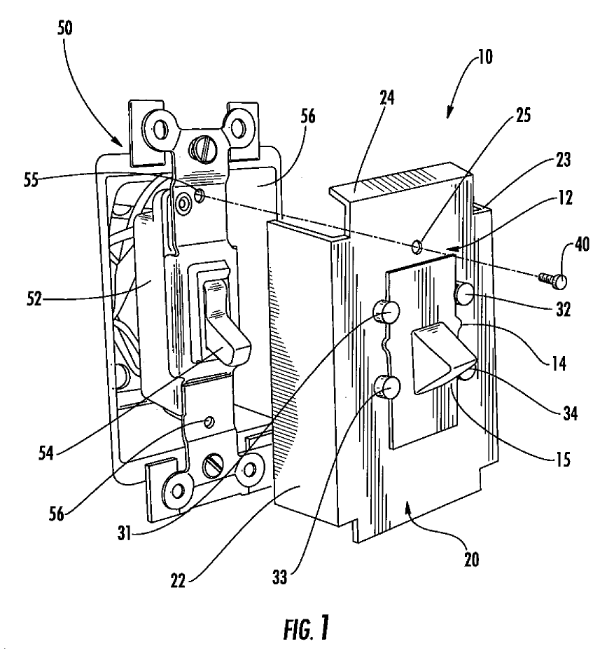

Referring now specifically to the drawings, an electrical switch cover according to a preferred embodiment of the invention is illustrated in FIGS. 1-4, and shown generally at reference numeral 10. As shown in FIG. 1, the switch cover 10 includes a casing 12 positioned on a panel section 20, and is adapted for use with a typical electrical switch 54 positioned within an electrical housing 50. As used throughout this application, “electrical housing” refers generally to any part of the structure surrounding an electrical switch, including the inner electrical unit 52 and the outer wall 56 surrounding the electrical unit 52 and switch 54. Although the switch cover 10 is described and shown in the drawings as being used in conjunction with an electrical switch 54, the invention is not so limited. It is contemplated that other embodiments of the invention can be used to cover moveable objects other than a switch. Furthermore, while the switch cover 10 is illustrated and described herein as being used to cover a one gang switch outlet, the invention is not so limited and can be used to cover various sizes of switch outlets, such as two gang and three gang switches.

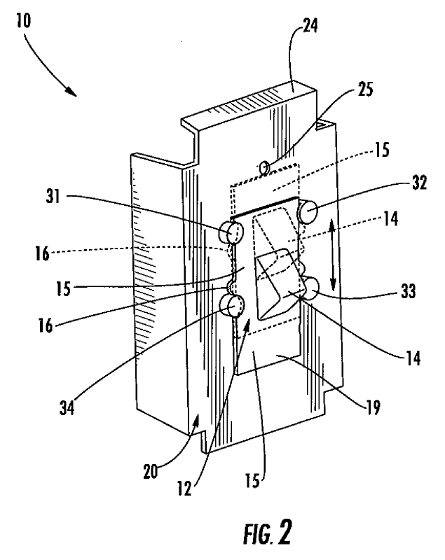

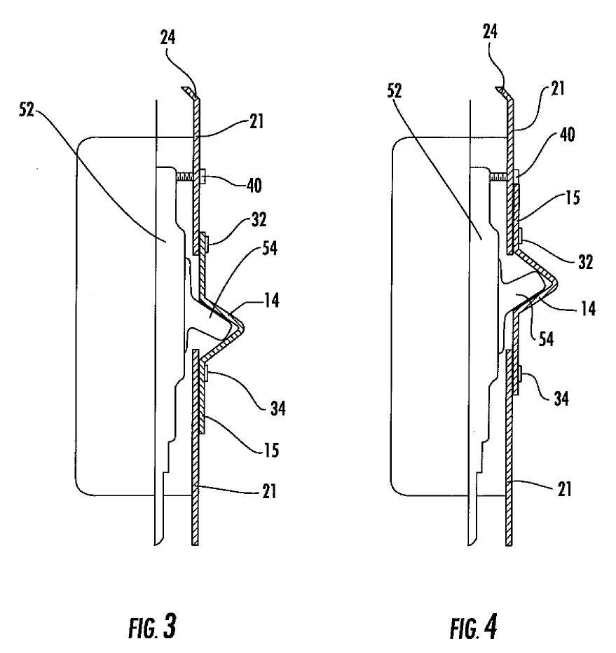

As shown in FIG. 1, the casing 12 includes a pyramid-shaped covering member 14 positioned on a substantially rectangular and flat base 15. The covering member 14 is sized and shaped such that it can receive and cover the switch 54, as shown in FIGS. 3-4. As shown in FIG. 2, the base 15 includes two stop members in the form of convex sections 16, 17 positioned on the left and right sides of the base 15, respectively.

The panel section 20 is comprised of a center panel 21, two side panels 22, 23 attached on the left and right sides, respectively, of the center panel 21, and an L-shaped top panel 24 extending from the top of the center panel 21. The panel section 20 is shaped and sized to cover the inner electrical unit 52 of the electrical housing 50. The center panel 21 has a central opening over which the casing 12 is positioned and which allows for the switch 54 to enter therethrough, as shown in FIGS. 3-4. The left and right side panels 22, 23 are inserted into the housing 50, and engage the inside surface of the outer wall 56.

The switch cover 10 includes means for removably attaching the panel section 20 to the electrical housing 50. For example, the panel section 20 includes a circular opening 25 that can be aligned with a female threaded opening 55 formed in the electrical unit 52 positioned above the switch 54. A fastener, such as a male threaded screw 40, can be inserted through the panel opening 25 and into the female threaded opening 55 of the electrical unit 52. The male threaded screw 40 engages the female threaded opening 55 thereby securely attaching the panel section 20 to the electrical housing 50, as shown in FIGS. 3-4. The casing 12 and the panel section 20 cover the electrical unit 52, and prevent paint or other undesirable material from contacting the electrical unit 52. In addition, the panel section 20 protects against electrical shock that could result from a worker's tool inadvertently contacting an electrically charged portion of the electrical unit 52.

In an alternative embodiment, the central panel 21 of the panel section 20 can include a second circular opening that could be aligned with a second female threaded opening 56 in the electrical unit 52 positioned below the switch 54. The second panel opening would be vertically aligned with and below the first opening 25. A fastener could be inserted through the second panel opening and into the second female threaded opening 56, thereby providing an alternative means for attaching the panel section 20 to the electrical housing 50.

Four receiving members in the form of circular guides 31-34 are positioned on the central panel 21. Each of the guides 31-34 has a channel formed therein for receiving the outer edge of the base 15. As shown in FIG. 2, guide 31 is positioned in horizontal alignment with guide 32 and vertical alignment with guide 33. Likewise, guide 34 is positioned in horizontal alignment with guide 33 and vertical alignment with guide 32. As such, the guides 31-34 are positioned at about what would be the four corners of a rectangle to provide a guided track on which the base 15 of the casing 12 can slidably move.

The base 15 is positioned within the guides 31-34 such that the convex stop members 16, 17 of the base 15 are intermediate the upper guides 31, 32 and the lower guides 33, 34. The guides 31-34 allow the casing 12 to slide vertically, but prevent further movement when the stop members 16, 17 contact the upper guides 31, 32 or the lower guides 33, 34. As shown in FIG. 2, the casing 12 can slide in a range of vertical motion between a lower-most position (shown in solid line) in which the stop members 16, 17 of the base 15 contact and rest upon the lower guides 33, 34, and an upper-most position (shown in broken lines), in which the stop members 16, 17 contact and rest against the upper guides 31, 32. FIG. 3 shows the electrical switch 54 in the “off” position when the casing 12 is in the lower-most position, and as shown in FIG. 4, the switch 54 is moved up to the “on” position by sliding the casing 12 up to the upper-most position. As such, the electrical switch 54 can be turned on and off, while maintaining the cover 10 on the switch 54 and the electrical housing 50. The ability to turn the switch 54 off and on without removing the cover 10 provides convenience for the user and reduces energy waste by eliminating the tendency of workers to leave electrical lights on when not working rather than spend the time necessary to remove and reattach a cover each time work is suspended and restarted.

Alternatively, the receiving members could be in the form of two elongate guides positioned on the left and right sides of the base 15 of the casing 12. The elongate guides would have channels that allow for the casing 12 to slide vertically on the center panel 21, but would prevent further movement where the stop members 16, 17 contacted the top or bottom ends of the elongate guides.

An electrical switch cover and method of using same are disclosed above. Various embodiments of the invention can be made without departing from its scope. Furthermore, the foregoing description of the preferred embodiment of the invention and the best mode for practicing the invention are provided for the purpose of illustration only and not for the purpose of limitation—the invention being defined by the claims.

1. (canceled)

2. (canceled)

3. (canceled)

4. (canceled)

5. (canceled)

6. (canceled)

7. (canceled)

8. (canceled)

9. (canceled)

10. (canceled)

11. A cover for temporarily covering a switch positioned within an electrical housing and recessed in a wall comprising:
a) a substantially rectangular panel section defined by a flat horizontal face, first and second opposed longitudinal sides, and first and second opposed lateral sides;
(b) attachment means for removably attaching the panel to the housing;
(c) a casing adapted to cover and contact the switch and mounted on the panel for a predetermined range of sliding movement on the panel, whereby sliding of the casing imparts movement to the switch; and
a pair of sidewalls including a first sidewall attached to the first longitudinal side of the panel, and a second sidewall attached to the second longitudinal side of the panel, wherein the first and second sidewalls are defined by horizontal faces having four edges that do not contact any other sidewall, and the pair of sidewalls are configured to fit within and contact the electrical housing thereby holding the cover against the housing.

12. A cover according to claim 11, wherein sliding of the casing imparts movement to the switch.

13. A cover according to claim 11, wherein the cover is removably attached within the housing.

14. A cover according to claim 13, wherein the fastener comprises a male threaded screw, and the complementary void comprises a female threaded opening.

15. A cover according to claim 11, wherein the casing comprises:
(a) a substantially flat base adapted for sliding movement on the panel; and
(b) a substantially pyramidal covering member extending outwardly from the base for receiving and covering the switch.

16. A cover according to claim 15, wherein the base includes at least one stopping member formed on a perimeter of the base, and further wherein the panel includes at least one receiving member that engages the stopping member at least two spaced apart points, wherein engagement of the stopping member and the receiving member prevent further movement of the base on the panel, whereby a permitted range of movement of the casing on the panel is limited to a predetermined area.

17. A cover according to claim 15, wherein the base is substantially rectangular and includes first and second stop members formed on opposing sides of the base, and the panel includes first and second pairs of spaced apart linearly aligned receiving members adapted for receiving and engaging the stop members, the base moveable between a first stopped position wherein the stop members engage the first pair of receiving members and a second stopped position wherein the stop members engage the second pair of receiving members, whereby movement of the casing on the panel is limited to an area lying between the first and second pairs of receiving members.

18. (canceled)

19. (canceled)

20. A cover according to claim 11, wherein the panel further comprises a third sidewall attached to the first lateral side of the panel, and the third sidewall is configured to fit within the electrical housing.

21. (canceled)
